(19) United States
(12) Patent Application Publication
(10) Pub. No.: US 2007/0136379 A1
(43) Pub. Date: Jun. 14, 2007

(54) Process for integrating and applying quality control on irregular time-series data

(76) Inventors: Darrell Dan Massie, Fort Montgomery, NY (US); John Mitchell Hill, West Point, NY (US); Peter Scott Curtiss, Boulder, CO (US); Michael Alan Miller, Shreveport, LA (US)

Correspondence Address: Darrell D. Massie, Attn: MADN-CME, 646 Swift Road, West Point, NY, 10996-1905, US

(21) Appl. No.: 10/980,632

(22) Filed: Feb. 14, 2005

(51) Int. Cl. G06F 17/30

(52) U.S. Cl. 707/200

(57) ABSTRACT

A process for integrating and applying quality control on irregular time-series data comprising the steps of: A component that accepts any number of tag points for integration over arbitrary, user-specified intervals, internal statistical algorithms for manipulating the data streams, routines for accepting values from external sources that can be either sequential on-line data streams or historic data files that simulate said data streams, and methods for identifying suspicious or erroneous data values.

### STATEMENT REGARDING FEDERALLY SPONSORED RESEARCH OR DEVELOPMENT

The U.S. Government has a paid-up license in this invention and the right in limited circumstances to require the patent owner to license others on reasonable terms as provided for by the terms of Contract #W911SD04P0299 awarded by DOD.

### CROSS REFERENCE TO RELATED APPLICATIONS

The present invention is similar to U.S. Pat. No. 6,604,104 (System and process for managing data within an operation data store) that receives data from different data sources and prioritizes them for distribution to a data store via a translation module. The present invention differs from this in that it applies both data quality algorithms and statistical manipulation for use by subsequent receiving components. The present invention also does not intend for the data to go to a data store but rather to model-based components that can return data back to the data integration tool.

### DESCRIPTION OF ATTACHED APPENDIX

Not Applicable

### BACKGROUND OF THE INVENTION

This invention relates generally to the field of process measurement and control and more specifically to a process for integrating and applying quality assurance on irregular time-series data. Within the past three decades, huge advancements have been made in the fields of computer-oriented measurement, modeling, and control. Along with these advancements, however, has also been a tremendous increase in the amount of data produced by the measurement systems. In many cases, the amount of available data far exceeds the needs of the model and control systems. There is a deficiency of components that can statistically manipulate such streams to set the effective data granularity, to allow another computer component to quickly retrieve key data characteristics, and to apply quality assurance algorithms.

Within this framework, therefore, the present invention has been developed as an efficient way of operating on data streams. The architecture of the described invention is a computed component that, once configured, acts independently and makes data available to other components through direct component-to-component communication.

### BRIEF SUMMARY OF THE INVENTION

The primary object of the invention is to provide integration of sequential data that occurs at irregular intervals.

Another object of the invention is to provide seamless switching between use of historic data files and on-line values.

Another object of the invention is to allow quality assurance of data using easy-to-modify data limits in xml format.

A further object of the invention is to provide embedded statistical information through a consistent interface.

Yet another object of the invention is to allow the use of easy-to-understand alphanumeric tag points for the identification of data channels.

Still yet another object of the invention is to provide easy interfacing with other components through the use of COM development.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed a process for integrating and applying quality control on irregular time-series data comprising the steps of:
1. the component accepts any number of tag points for integration over arbitrary, user-specified intervals,
2. internal statistical algorithms for manipulating the data streams,
3. routines for accepting values from external sources that can be either sequential on-line data streams or historic data files that simulate said data streams, and
4. methods for identifying suspicious or erroneous data values.

The invention, hereafter referred to as the integration component, operates as a stand-alone component that runs in the background of a Microsoft Windows environment. The component works as a COM application, allowing other programs to communicate directly with it. It has two basic modes of operation:
a “manual” mode where raw data are pushed to the integration component from another component. This mode is typically used when the data supplied to the integration component typically come from a file of historic data and is meant to simulate the on-line behavior. This is useful for testing algorithms and process control before the system is put on-line
an “automatic” mode where raw data are pulled from another component by the integration component. This mode represents the operation of the component in a real-time process control environment. In this mode, raw data are integrated at an interval as specified by the user. Once this occurs, a flag is raised by the component indicating that new processed data are available. The flag remains raised until cleared by a calling component.
   The difference between these two modes is strictly in how raw data are supplied to the component. In all other aspects of operation the two modes are the same.

The integration component has a number of unique properties and methods that are described in brief below
The UseQA property is set or cleared depending on whether the user wants to apply quality assurance algorithms to the raw data. The name of the file containing the data quality limits is set with the GetQAFromXMLFile method.
The AddRequestedTag method is used to specify a tag name (an alphanumeric string) used to identify a particular data stream. All incoming and outgoing data streams are associated with a unique tag. An external component can obtain information about the quantity and string values of tags already entered into the integration component using the NumberOfRequestedTags and RequestedTag functions. The processed numerical value associated with a tag is retrieved using the RequestedTagValue function where the data streams can be referred to by the index of the order in which they were entered or by the tag itself.
The IntegrateFromFile method is used to put the integration component into manual mode. When operating in manual mode, raw data are added to the component using the AddNewValue method. Data are added one at a time and are associated with a tag when entered. After the desired number of values for a given interval are added, the user forces the statistics calculation using the ForceEndOfinterval method.
The IntegrateOnLine method is used to put the integration component into automatic mode. When in automatic mode, the time until the current integration interval is concluded can be obtained through the SecondsToNextReading function. The size of the integration interval is set through the Interval property. The NewValuesAvailable property is set to true in automatic mode when a data interval has elapsed and new integrated values are available.
   When retrieving data from the component using the RequestedTagValue function and the tag, a number of suffixes can be appended to the tag that modify the value of the returned data. For example, an external component may get the average value of a data stream identified by the tag “Temperature” with the call

Average=IntegratorComponent.RequestedTagValue(“Temperature”) but can get the number of raw values of this data stream used to calculate the average through the use of the tag suffix “count” as shown here

Number=IntegratorComponent.RequestedTagValue(“Temperature.COUNT”) The supported tag suffixes are shown in the following table

| Suffix | Return value |
|---|---|
| .AVG or .MEAN* | average of values taken over integration interval |
| .COUNT or .NUMREC | number of raw values taken over integration interval |
| .MAX | maximum of all values taken over the integration interval |
| .MIN | minimum of all values taken over the integration interval |
| .RANGE | difference between the maximum and minimum of all values |
| | taken over the integration interval |
| .STDDEV | standard deviation of all values taken over integration interval |
| .STDDEVM | standard deviation about the mean of all values taken over |
| | integration interval |
| .TOTAL | total of all values taken over integration interval |

*This is the default

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a flow chart showing addition of tag names to data integration component.

FIG. 2 is a flow chart showing specification of file containing quality assurance limits.

FIG. 3 is a flow chart showing the operation of the component using external data files

FIG. 4 is a flow chart showing the operation of the component using on-line data streams

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

The figures are all schematic representations of the different portions of this invention. Preferred embodiments of the present invention are now described with reference to the accompanying drawings.

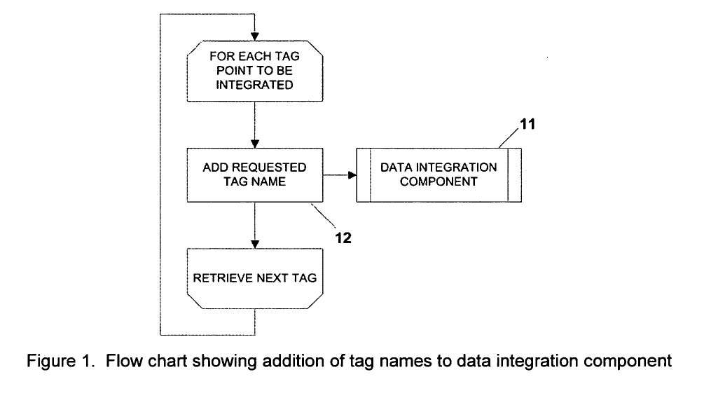

With reference to FIG. 1, the process for adding tag points to the data integration component is depicted. The integration component 11 can use any combination of alphanumeric characters to uniquely identify a given data stream. Such a combination of characters is called the tag name 12. These tag names are used later when requesting the modified values of each data stream. A calling component cycles through all tag names and adds them to the data integration component.

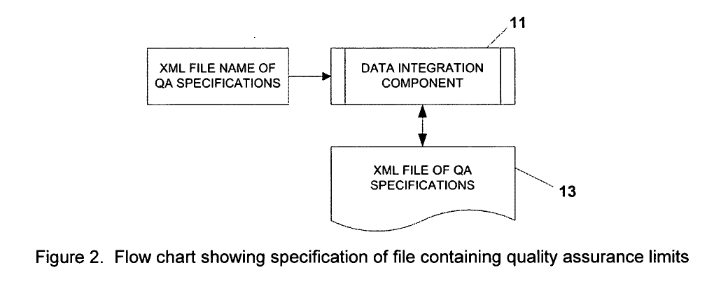

With reference to FIG. 2, the quality assurance file specification is shown as a simple procedure whereby the name of a xml file 13 in the proper format is passed to the integration component 11. The xml file contains a number of nodes, each one of which specify a tag name, absolute upper and lower limits, and slope (change over time) upper and lower limits.

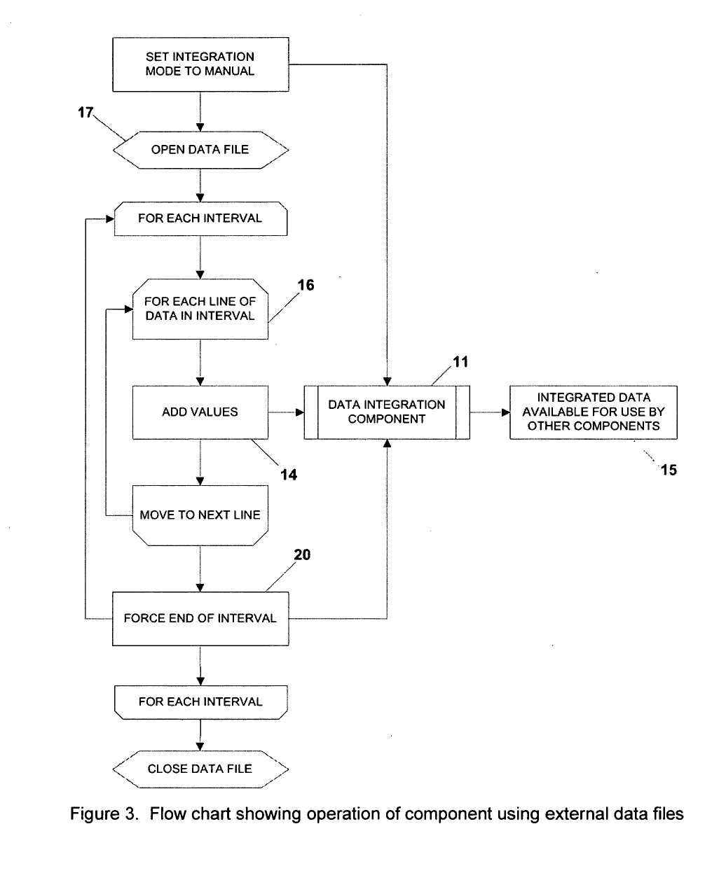

With reference to FIG. 3, the integration from external data file flow chart shows how historic data are read from an external file and acted upon by the integration component. In a normal cycle of operation, the following occurs.
The mode of the data integration component 11 is set to manual, indicating that it will be experiencing data given to it by another, external component.
A data file containing historic values that correspond to the tag names already entered (vis. FIG. 1) is opened.
Over a given interval set by the calling component, a number of lines of data 16 are read sequentially from the file and added 14 to the integration component 11.
At the end of a given interval the calling component sends a force-end-of-interval 20 command to the integration component.
At any point an external component 15 can request to see if new integrated data are available from the integration component and can request the current or past integrated values from the integration component.

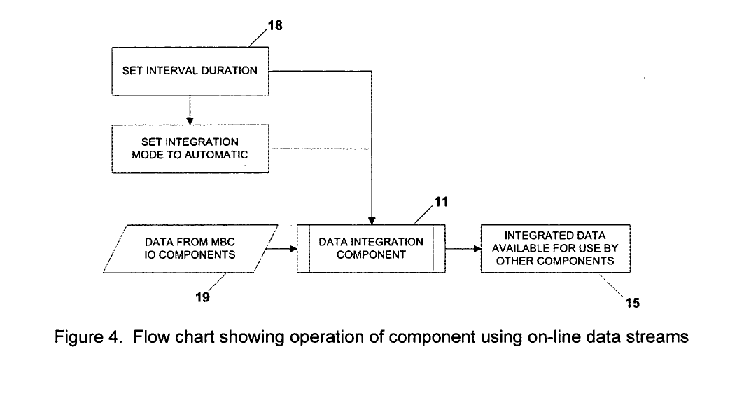

With reference to FIG. 4, the integration of on-line data flow chart shows how live data are captured from existing data gathering components and acted upon by the integration component. In a normal cycle of operation, the following occurs.
An interval in seconds is set in the data integration component 11 that is used to determine when the statistical manipulation of captured data should occur.
The mode of the data integration component 11 is set to automatic, indicating that it should be capturing data from any available data gathering components.
One the mode is set to automatic the component will begin to gather data from existing input/output components 19 at whatever interval the raw values are measured.
At any point an external component 15 can request to see if new integrated data are available from the integration component and can request the current or past integrated values from the integration component.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. A process for integrating and applying quality control on irregular time-series data comprising the steps of:
accepting any number of tag points used to uniquely identify;
accepting an arbitrary integration interval; and
automatically retrieving data and applying statistical manipulation to provide average data across the interval

2. A process for easily switching the integration process described in claim 1 between archived data and live data.

3. A process for providing data quality assurance simultaneous with the actions described in claims 1 and 2.

4. A process for providing component-to-component communication for setting and retrieving the data files via the use of alphanumeric tag descriptors.
